(19) United States
(12) Patent Application Publication
(10) Pub. No.: US 2026/0239042 A1
(43) Pub. Date: Aug. 13, 2026

(54) WIRELESS COMMUNICATION METHOD, TERMINAL DEVICE AND NETWORK DEVICE

(71) Applicant: GUANGDONG OPPO MOBILE TELECOMMUNICATIONS CORP., LTD., Dongguan (CN)

(72) Inventor: Hao LIN, Dongguan (CN)

(73) Assignee: GUANGDONG OPPO MOBILE TELECOMMUNICATIONS CORP., LTD., Dongguan (CN)

(21) Appl. No.: 19/562,155

(22) Filed: Mar. 10, 2026

Related U.S. Application Data
(63) Continuation of application No. PCT/CN2023/118458, filed on Sep. 13, 2023.

(51) Int. Cl. H04W 24/04; H04W 64/00

(52) U.S. Cl. CPC H04W 24/04; H04W 64/006

(57) ABSTRACT

Provided are a wireless communication method, a terminal device, and a network device. The method comprises: if a first condition is met, a first terminal device triggering a first signal, wherein the first condition is associated with one or more of the following: failure in detection of a first channel, the first channel being configured to schedule the transmission of paging information of the first terminal device; failure in reception of a second channel, the second channel being configured to transmit the paging information of the first terminal device; and the quality of reception of a second signal.

### CROSS-REFERENCE TO RELATED APPLICATIONS

This application is a continuation of International Application No. PCT/CN2023/118458, filed on September 13, 2023, the disclosure of which is hereby incorporated by reference in its entirety.

### TECHNICAL FIELD

This application relates to the field of communications technologies, and more specifically, to a wireless communication method, a terminal device, and a network device.

### BACKGROUND

Some communications systems (such as satellite communications systems) have strict requirements on receiving conditions of terminal devices. Otherwise, communication quality of the terminal devices deteriorates sharply. When the communication quality deteriorates, how to alert a user of a terminal device is a problem that needs to be resolved.

### SUMMARY

This application provides a wireless communication method, a terminal device, and a network device. The following describes in detail the aspects related to this application.

According to a first aspect, a wireless communication method is provided, including: triggering, by a first terminal device, a first signal if a first condition is met, where the first condition is associated with one or more of the following: detection failure of a first channel, where the first channel is used to schedule transmission of paging information of the first terminal device; reception failure of a second channel, where the second channel is used to transmit paging information of the first terminal device; or received quality of a second signal.

According to a second aspect, a wireless communication method is provided, including: receiving, by a first terminal device, a first signal sent by a network device, where the first signal is associated with paging failure of the first terminal device.

According to a third aspect, a wireless communication method is provided, including: sending, by a network device, a first signal to a first terminal device, where the first signal is associated with paging failure of the first terminal device.

According to a fourth aspect, a terminal device is provided, where the terminal device is a first terminal device, and the first terminal device includes: a triggering module, configured to trigger a first signal if a first condition is met, where the first condition is associated with one or more of the following: detection failure of a first channel, where the first channel is used to schedule transmission of paging information of the first terminal device; reception failure of a second channel, where the second channel is used to transmit paging information of the first terminal device; or received quality of a second signal.

According to a fifth aspect, a terminal device is provided, where the terminal device is a first terminal device, and the first terminal device includes: a communication module, configured to receive a first signal sent by a network device, where the first signal is associated with paging failure of the first terminal device.

According to a sixth aspect, a network device is provided, including: a communication module, configured to send a first signal to a first terminal device, where the first signal is associated with paging failure of the first terminal device.

According to a seventh aspect, a terminal device is provided, including a memory and a processor, where the memory is configured to store a program, and the processor is configured to invoke the program in the memory, to cause the terminal device to execute the method according to the first aspect or the second aspect.

According to an eighth aspect, a network device is provided, including a memory and a processor, where the memory is configured to store a program, and the processor is configured to invoke the program in the memory, to cause the network device to execute the method according to the third aspect.

According to a ninth aspect, an apparatus is provided, including a processor, configured to invoke a program from a memory, to cause the apparatus to execute the method according to any one of the first aspect to the third aspect.

According to a tenth aspect, a chip is provided, including a processor, configured to invoke a program from a memory, to cause a device on which the chip is installed to execute the method according to any one of the first aspect to the third aspect.

According to an eleventh aspect, a computer-readable storage medium is provided, where the computer-readable storage medium stores a program, and the program causes a computer to execute the method according to any one of the first aspect to the third aspect.

According to a twelfth aspect, a computer program product is provided, including a program, where the program causes a computer to execute the method according to any one of the first aspect to the third aspect.

According to a thirteenth aspect, a computer program is provided, where the computer program causes a computer to execute the method according to any one of the first aspect to the third aspect.

### BRIEF DESCRIPTION OF DRAWINGS

FIG. 1A is an example diagram of a communication scenario to which an embodiment of this application is applicable.

FIG. 1B is an example diagram of another communication scenario to which an embodiment of this application is applicable.

FIG. 1C is an example diagram of still another communication scenario to which an embodiment of this application is applicable.

FIG. 2 is a schematic flowchart of a wireless communication method according to an embodiment of this application.

FIG. 3 is an example diagram of a possible implementation of the method shown in FIG. 2.

FIG. 4 is an example diagram of another possible implementation of the method shown in FIG. 2.

FIG. 5 is an example diagram of still another possible implementation of the method shown in FIG. 2.

FIG. 6 is an example diagram of still another possible implementation of the method shown in FIG. 2.

FIG. 7 is a schematic flowchart of a wireless communication method according to another embodiment of this application.

FIG. 8 is an example diagram of a possible implementation of the method shown in FIG. 7.

FIG. 9 is an example diagram of another possible implementation of the method shown in FIG. 7.

FIG. 10 is an example diagram of still another possible implementation of the method shown in FIG. 7.

FIG. 11 is a schematic structural diagram of a terminal device according to an embodiment of this application.

FIG. 12 is a schematic structural diagram of a terminal device according to another embodiment of this application.

FIG. 13 is a schematic structural diagram of a network device according to an embodiment of this application.

FIG. 14 is a schematic diagram of an apparatus to which an embodiment of this application is applicable.

### DESCRIPTION OF EMBODIMENTS

Communications system architecture

The technical solutions in embodiments of this application may be applied to various communications systems, for example, a global system for mobile communications (global system of mobile communication, GSM), a code-division multiple access (code division multiple access, CDMA) system, a wideband code-division multiple access (wideband code division multiple access, WCDMA) system, general packet radio service (general packet radio service, GPRS), a long-term evolution (long term evolution, LTE) system, an advanced long-term evolution (advanced long term evolution, LTE-A) system, a new radio (new radio, NR) system, an evolved system of an NR system, an LTE-based access to unlicensed spectrum (LTE-based access to unlicensed spectrum, LTE-U) system, an NR-based access to unlicensed spectrum (NR-based access to unlicensed spectrum, NR-U) system, an NTN system, a universal mobile telecommunications system (universal mobile telecommunication system, UMTS), a wireless local area network (wireless local area networks, WLAN), wireless fidelity (wireless fidelity, WiFi), a fifth-generation (5th-generation, 5G) system, or another communications system, for example, a future communications system such as a sixth-generation mobile communications system or a satellite communications system.

Generally, a number of connections supported by a conventional communications system is limited, and is also easy to implement. However, with development of communication technologies, a mobile communications system not only supports conventional communication, but also supports, for example, device-to-device (device to device, D2D) communication, machine-to-machine (machine to machine, M2M) communication, machine type communication (machine type communication, MTC), vehicle-to-vehicle (vehicle to vehicle, V2V) communication, or vehicle-to-everything (vehicle to everything, V2X) communication. Embodiments of this application may also be applied to these communications systems.

The communications system in embodiments of this application may be applied to a carrier aggregation (carrier aggregation, CA) scenario, a dual connectivity (dual connectivity, DC) scenario, or a standalone (standalone, SA) networking scenario.

The communications system in embodiments of this application may be applied to an unlicensed spectrum, and the unlicensed spectrum may also be considered as a shared spectrum. Alternatively, the communications system in embodiments of this application may be applied to a licensed spectrum, and the licensed spectrum may also be considered as a dedicated spectrum.

Embodiments of this application may be applied to an NTN system, or may be applied to a terrestrial communication network (terrestrial networks, TN) system. By way of example and without limitation, the NTN system includes an NR-based NTN system and an IoT-based NTN system.

Embodiments of this application are described with reference to a network device and a terminal device. The terminal device may also be referred to as user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal, a wireless communications device, a user agent, a user apparatus or the like.

In embodiments of this application, the terminal device may be a station (STATION, ST) in a WLAN, or may be a cellular phone, a cordless phone, a session initiation protocol (session initiation protocol, SIP) phone, a wireless local loop (wireless local loop, WLL) station, a personal digital assistant (personal digital assistant, PDA) device, a handheld device with a wireless communication function, a computing device or another processing device connected to a wireless modem, a vehicle-mounted device, a wearable device, a next-generation communications system such as a terminal device in an NR network, or a terminal device in a future evolved public land mobile network (public land mobile network, PLMN) network.

In embodiments of this application, the terminal device may be a device providing a user with voice and/or data connectivity and capable of connecting people, objects, and machines, such as a handheld device or a vehicle-mounted device having a wireless connection function. The terminal device in embodiments of this application may be a mobile phone, a tablet computer (Pad), a notebook computer, a palmtop computer, a mobile internet device (mobile internet device, MID), a wearable device, a virtual reality (virtual reality, VR) device, an augmented reality (augmented reality, AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. Optionally, the terminal device may be configured to serve as a base station. For example, the terminal device may function as a scheduling entity, which provides a sidelink signal between terminal devices in V2X, D2D, or the like. For example, a cellular phone and a vehicle communicate with each other through a sidelink signal. A cellular phone and a smart home device communicate with each other, without relaying a communication signal through a base station.

In embodiments of this application, the terminal device may be deployed on land, including being indoors or outdoors, handheld, wearable, or vehicle-mounted. The terminal device may also be deployed on water (for example, on a ship), or may be deployed in the air (for example, on an airplane, an air balloon, or a satellite).

In embodiments of this application, the terminal device may be a mobile phone (Mobile Phone), a tablet computer (Pad), a computer with a wireless transceiver function, a virtual reality (Virtual Reality, VR) terminal device, an augmented reality (Augmented Reality, AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, or the like. The terminal device in embodiments of this application may also be referred to as a terminal, user equipment (user equipment, UE), an access terminal device, a vehicle-mounted terminal, an industrial control terminal, a UE unit, a UE station, a mobile site, a mobile station, a remote station, a remote terminal device, a mobile device, UE, a wireless communications device, a UE agent, a UE apparatus, or the like. The terminal device may also be a fixed or mobile terminal device.

By way of example rather than limitation, in embodiments of this application, the terminal device may alternatively be a wearable device. The wearable device may also be referred to as an intelligent wearable device, and is a general term for wearable devices such as glasses, gloves, watches, clothes, and shoes that are intelligently designed and developed based on daily wearing by using a wearable technology. The wearable device is a portable device that can be directly worn or integrated into clothes or accessories of a user. In addition to being a hardware device, the wearable device can also realize various functions through software support, data interaction, and cloud interaction. In a broad sense, wearable smart devices may include a full-featured and large-sized device that can provide full or partial functions without relying on a smart phone, for example, a smart watch or smart glasses, and devices that focus on only a specific type of application function and need to cooperate with another device such as a smart phone for use, for example, various smart bracelets and smart jewelries for physical sign monitoring.

The network device in embodiments of this application may be a device configured to communicate with the terminal device. The network device may also be referred to as an access network device or a radio access network device. For example, the network device may be a base station. The network device in embodiments of this application may be a radio access network (radio access network, RAN) node (or device) that connects the terminal device to a wireless network. The base station may broadly cover the following various names, or may be replaced with the following names, such as a NodeB, an evolved NodeB (evolved NodeB, eNB), a next-generation NodeB (next generation NodeB, gNB), a relay station, an access point, a transmitting and receiving point (transmitting and receiving point, TRP), a transmitting point (transmitting point, TP), a master eNodeB (MeNB), a secondary eNodeB (SeNB), a multi-standard radio (MSR) node, a home eNodeB, a network controller, an access node, a radio node, an access point (access point, AP), a transmission node, a transceiver node, a baseband unit (base band unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), and a positioning node. The base station may be a macro base station, a micro base station, a relay node, a donor node, or the like, or a combination thereof. Alternatively, the base station may be a communication module, a modem, or a chip disposed in the device or apparatus described above. Alternatively, the base station may be a mobile switching center, a device that functions as a base station in device-to-device D2D, vehicle-to-everything (vehicle-to-everything, V2X), and machine-to-machine (machine-to-machine, M2M) communication, a network-side device in a 6G network, a device that functions as a base station in a future communications system, or the like. The base station may support networks of a same access technology or different access technologies. A specific technology and a specific device used by the network device are not limited in embodiments of this application.

The base station may be a fixed or mobile base station. For example, a helicopter or an unmanned aerial vehicle may be configured to act as a mobile base station, and one or more cells may move based on a position of the mobile base station. In another example, a helicopter or an unmanned aerial vehicle may be configured to serve as a device in communication with another base station.

In some deployments, the network device in embodiments of this application may be a CU or a DU, or the network device may include a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of this application, a scenario of the network device and the terminal device is not limited.

By way of example rather than limitation, in embodiments of this application, the network device may have a mobility characteristic. For example, the network device may be a mobile device. In some embodiments of this application, the network device may be a satellite or a balloon station. For example, the satellite may be a low earth orbit (low earth orbit, LEO) satellite, a medium earth orbit (medium earth orbit, MEO) satellite, a geostationary earth orbit (geostationary earth orbit, GEO) satellite, a high elliptical orbit (High Elliptical Orbit, HEO) satellite, or the like. In some embodiments of this application, the network device may alternatively be a base station located on land, water, or the like.

In embodiments of this application, the network device may provide a service for a cell, and the terminal device communicates with the network device by using a transmission resource (for example, a frequency domain resource or a spectrum resource) used by the cell. The cell may be a cell corresponding to the network device (for example, a base station). The cell may belong to a macro base station or belong to a base station corresponding to a small cell. The small cell herein may include a metro cell, a micro cell, a pico cell, a femto cell, or the like. These small cells feature small coverage and low transmit power, and are suitable for providing a high-speed data transmission service.

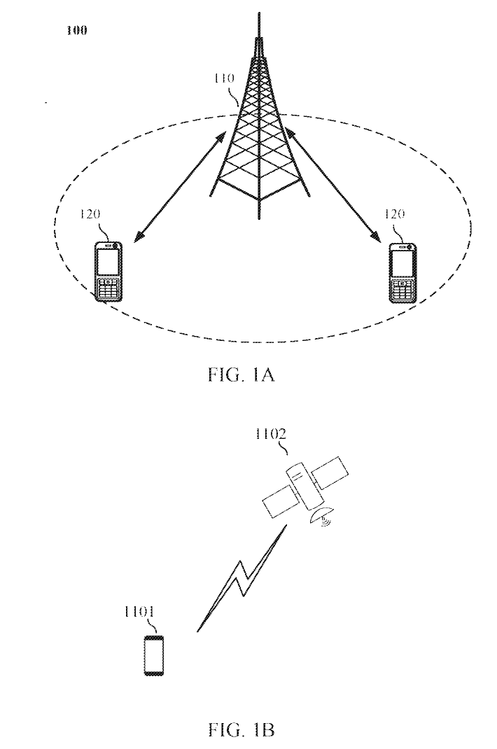

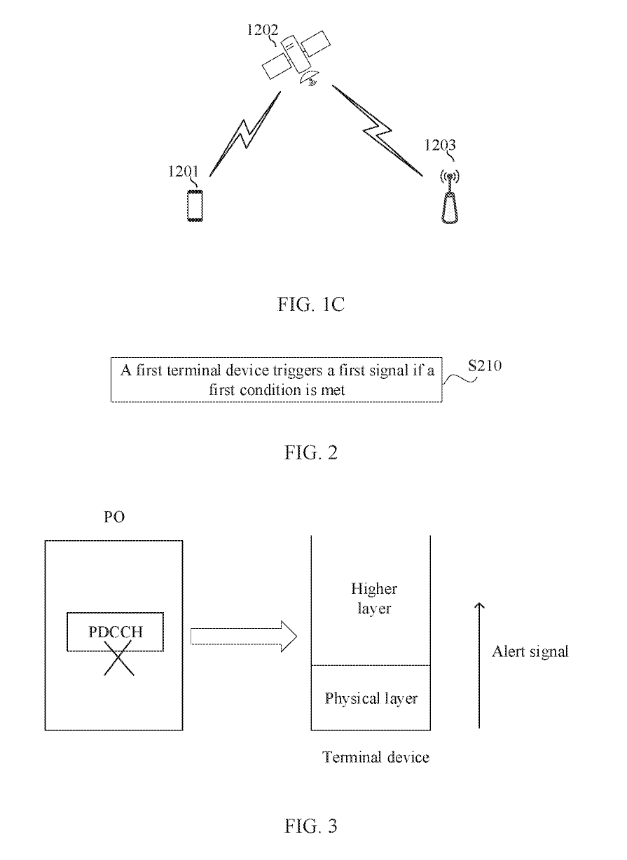

Exemplarily, FIG. 1A is a schematic diagram of an architecture of a communications system according to an embodiment of this application. As shown in FIG. 1A, the communications system 100 may include a network device 110, and the network device 110 may be a device that communicates with a terminal device 120 (or referred to as a communications terminal or a terminal). The network device 110 may provide communication coverage for a specific geographical region, and may communicate with a terminal device within the coverage region.

FIG. 1A exemplarily shows one network device and two terminal devices. In some embodiments of this application, the communications system 100 may include a plurality of network devices and another quantity of terminal devices may be included within a coverage area of each network device, which is not limited in embodiments of this application.

Exemplarily, FIG. 1B is a schematic diagram of an architecture of another communications system according to an embodiment of this application. Referring to FIG. 1B, a terminal device 1101 and a satellite 1102 are included, and wireless communication may be performed between the terminal device 1101 and the satellite 1102. A network formed between the terminal device 1101 and the satellite 1102 may also be referred to as an NTN. In the architecture of the communications system shown in FIG. 1B, the satellite 1102 may have a function of a base station, and direct communication may be performed between the terminal device 1101 and the satellite 1102. Under this system architecture, the satellite 1102 may be referred to as a network device. In some embodiments of this application, the communications system may include a plurality of network devices 1102, and another quantity of terminal devices may be included within a coverage range of each network device 1102, which is not limited in embodiments of this application.

Exemplarily, FIG. 1C is a schematic diagram of an architecture of another communications system according to an embodiment of this application. Referring to FIG. 1C, a terminal device 1201, a satellite 1202, and a base station 1203 are included, wireless communication may be performed between the terminal device 1201 and the satellite 1202, and communication may be performed between the satellite 1202 and the base station 1203. A network formed between the terminal device 1201, the satellite 1202, and the base station 1203 may also be referred to as an NTN. In the architecture of the communications system shown in FIG. 1C, the satellite 1202 may not have a function of a base station, and communication between the terminal device 1201 and the base station 1203 needs to be forwarded by using the satellite 1202. Under this type of system architecture, the base station 1203 may be referred to as a network device. In some embodiments of this application, the communications system may include a plurality of network devices 1203, and another quantity of terminal devices may be included within a coverage range of each network device 1203, which is not limited in embodiments of this application.

It should be noted that FIG. 1A to FIG. 1C are merely examples of systems to which this application is applicable. Certainly, the methods shown in embodiments of this application may also be applied to another system, such as a 5G communications system or an LTE communications system. This is not specifically limited in embodiments of this application.

In some embodiments of this application, the wireless communications systems shown in FIG. 1A to FIG. 1C may further include another network entity such as a mobility management entity (mobility management entity, MME) or an access and mobility management function (access and mobility management function, AMF), which is not limited in embodiments of this application.

It should be understood that in embodiments of this application, a device having a communication function in a network or a system may be referred to as a communications device. The communications system 100 shown in FIG. 1A is used as an example. The communications device may include a network device 110 and a terminal device 120 that have a communication function. The network device 110 and the terminal device 120 may be the foregoing specific devices, and details are not described herein again. The communications device may further include another device in the communications system 100, such as a network controller or a mobility management entity. This is not limited in embodiments of this application.

It should be understood that, in embodiments of this application, “indication” mentioned herein may refer to a direct indication, or may refer to an indirect indication, or may mean that there is an association relationship. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association relationship between A and B.

In descriptions of embodiments of this application, the term “corresponding” may mean that there is a direct or indirect correspondence between two elements, or that there is an association relationship between two elements, or that there is a relationship of “indicating” and “being indicated”, “configuring” and “being configured”, or the like.

“Configured” in embodiments of this application may include being configured by using at least one of a system message, radio resource control (radio resource control, RRC) signaling, or a medium access control control element (media access control control element, MAC CE).

In some embodiments of this application, “predefined” or “preset” may be implemented by pre-storing corresponding codes, tables, or other forms that can be used to indicate related information in devices (for example, including the terminal device and the network device), and a specific implementation thereof is not limited in this application. For example, being predefined may refer to being defined in a protocol.

In some embodiments of this application, the “protocol” may refer to a standard protocol in the communication field, which may include, for example, an LTE protocol, an NR protocol, and a related protocol applied to a future communications system. This is not limited in this application.

In some communications systems (such as satellite communications systems), a terminal device needs to point an antenna of the terminal device toward the sky so that a receiver can obtain good signal quality or a good signal-to-noise ratio. However, in some cases, the receiver of the terminal device may not in a good receiving condition. For example, communication quality of the terminal device may drop sharply when a user places the terminal device in an inside pocket, or when the user is moving into an area in which the sky is not visible (for example, inside a tunnel or building). A decline in the communication quality may cause a severe problem. For example, if the terminal device has an important call coming in at this moment, it is highly likely that the terminal device will miss the call.

To address the problem described above, embodiments of this application are described in detail below. Embodiments of this application may be applied to any type of communications system mentioned above. For example, embodiments of this application may be applied to communication in a licensed band or an unlicensed band in NR.

FIG. 2 is a schematic flowchart of a wireless communication method according to an embodiment of this application. The method illustrated in FIG. 2 may be executed by a first terminal device. For example, the first terminal device may be a terminal device that supports NTN communication (such as satellite communication).

Referring to FIG. 2, in Step S210, the first terminal device triggers a first signal if a first condition is met.

In some implementations, the first signal may be sent from a physical layer of the first terminal device to a higher layer of the physical layer.

In some implementations, the first signal is an alert signal.

In some implementations, the first signal is associated with paging failure of the first terminal device. For example, the first signal is triggered in a case that paging of the first terminal device fails. For another example, the first signal is used to indicate that paging of the first terminal device fails.

In some implementations, the first signal is used to indicate that a location of the first terminal device is unfavorable for signal reception from a network device. Alternatively, the first signal may be used to instruct the user of the terminal device to move to a location that facilitates signal reception from the network device.

Satellite communication is used as an example. The first signal may be used to notify (for example, through a user interface of the first terminal device) the user of the first terminal device that the first terminal device may be located in a location or area with poor satellite signal reception, for example, the first terminal device is in a pocket or under a roof that shields satellite signals. Based on the first signal, the user of the first terminal device may move to a location or area suitable for receiving satellite signals.

In some implementations, the first signal is used to trigger the first terminal device to initiate a random access procedure, that is, a random access channel (random access channel, RACH) procedure.

In some implementations, the first condition is associated with detection failure of a first channel. The first channel may be used to schedule transmission of paging information of the first terminal device.

In some implementations, the first channel may be transmitted at time corresponding to a first paging occasion (paging occasion, PO). Accordingly, the terminal device may detect the first channel in the first paging occasion.

In some implementations, the first channel may be, for example, a physical downlink control channel (physical downlink control channel, PDCCH). The PDCCH may be used to schedule a PDSCH, and the paging information of the first terminal device is carried in the PDSCH.

In some implementations, the first condition may include that detection of the first channel fails. In other words, if detection of the first channel fails, the first terminal device triggers the first signal.

FIG. 3 is used as an example. The network device may transmit a PDCCH in a PO, and the PDCCH is used to schedule transmission of the paging information of the first terminal device. Accordingly, the first terminal device may detect the PDCCH in the PO. If detection of the PDCCH fails, the physical layer of the first terminal device sends an alert signal to the higher layer. From a perspective of the network device (such as a base station), the detection failure of the PDCCH may mean that the network device has sent the PDCCH in the PO, but the first terminal device has not received the PDCCH. From a perspective of the first terminal device, the detection failure of the PDCCH may mean that the first terminal device is monitoring the PDCCH (that is, the first terminal device is performing PDCCH monitoring), but has not detected the PDCCH.

In some implementations, the first condition may include a number of detection failures of the first channel reaching a first threshold. In other words, if the number of detection failures of the first channel reaches the first threshold, the first terminal device triggers the first signal. The first threshold may be determined based on configuration information or pre-configuration information of the network device, or autonomous implementation by the first terminal device. Through setting of the first threshold, frequent interruptions of the first terminal device by the first signal can be avoided, thereby improving user experience.

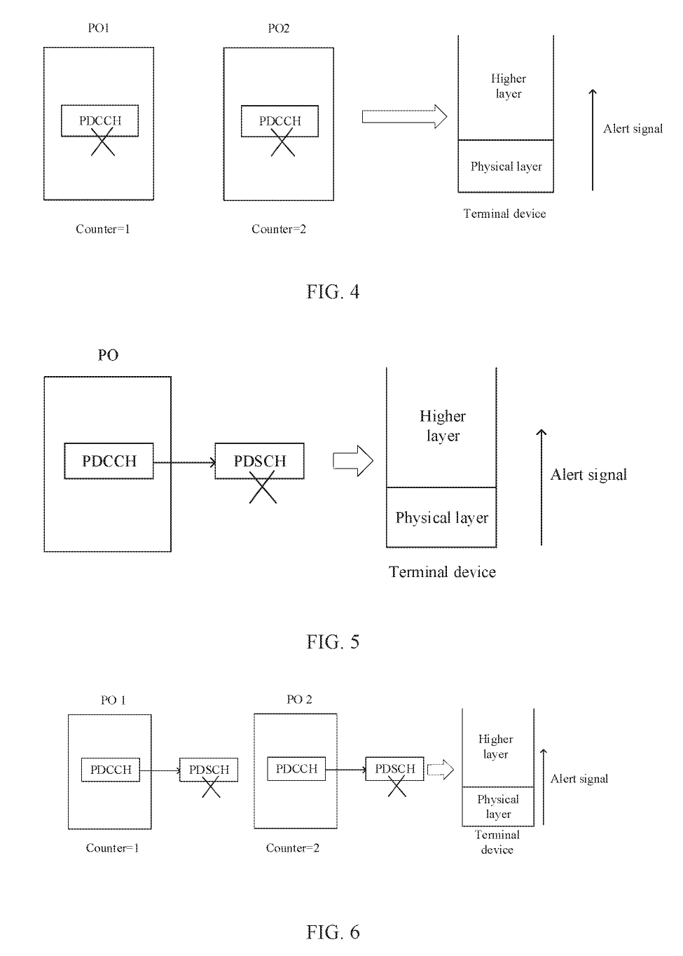

The first threshold being 2 is used as an example for description. Referring to FIG. 4, the network device may transmit a PDCCH separately in PO 1 and PO 2, and the PDCCH is used to schedule transmission of paging information of the first terminal device. Accordingly, the first terminal device may perform detection on the PDCCH in PO 1. If detection of the PDCCH fails, a value of a counter of the first terminal device changes from 0 to 1. Then, the first terminal device may perform detection on the PDCCH in PO 2. If detection of the PDCCH fails, the value of the counter of the first terminal device changes from 1 to 2. Since the value of the counter has reached the first threshold, the physical layer of the first terminal device sends an alert signal to the higher layer. Alternatively, an initial value of the counter may be set to 2. If detection of the PDCCH in PO 1 fails, the counter is decremented by 1; and if detection of the PDCCH in PO 2 fails, the counter is decremented by 1 again. When the value of the counter is 0, the physical layer of the first terminal device sends an alert signal to the higher layer.

In some implementations, the first condition is associated with reception failure of a second channel. The second channel is used to transmit the paging information of the first terminal device.

In some implementations, the second channel is a physical downlink shared channel (physical downlink shared channel, PDSCH). The PDSCH may be used to carry the paging information of the first terminal device. The PDSCH may be scheduled based on the PDCCH. Before receiving the PDSCH, the terminal device may first perform detection on the PDCCH.

In some implementations, the first condition may include reception failure of the second channel. In other words, if reception of the second channel fails, the first terminal device triggers the first signal.

FIG. 5 is used as an example. The network device may transmit a PDCCH in a PO, and the PDCCH is used to schedule transmission of the paging information of the first terminal device. Accordingly, the first terminal device may perform detection on the PDCCH on the PO and receive a PDSCH based on the detected PDCCH. If reception of the PDSCH fails, the physical layer of the first terminal device sends an alert signal to the higher layer.

In some implementations, the first condition may include a number of reception failures of the second channel reaching a second threshold. In other words, if the number of reception failures of the second channel reaches the second threshold, the first terminal device triggers the first signal. The second threshold may be determined based on configuration information or pre-configuration information of the network device, or autonomous implementation by the first terminal device. Through setting of the second threshold, frequent interruptions of the first terminal device by the first signal can be avoided, thereby improving user experience.

The second threshold being 2 is used as an example for description. Referring to FIG. 6, the network device may transmit a PDCCH separately in PO 1 and PO 2, and the PDCCH is used to schedule transmission of paging information of the first terminal device. Accordingly, the first terminal device may perform detection on the PDCCH on PO 1 and receive a PDSCH based on the detected PDCCH. If reception of the PDSCH fails, a value of a counter of the first terminal device changes from 0 to 1. Then, the first terminal device may perform detection on the PDCCH on PO 2 and receive a PDSCH based on the detected PDCCH. If reception of the PDSCH fails, the value of the counter of the first terminal device changes from 1 to 2. Since the value of the counter has reached the second threshold, the physical layer of the first terminal device sends an alert signal to the higher layer. Alternatively, an initial value of the counter may be set to 2. If reception of the PDSCH scheduled by the PDCCH on PO 1 fails, the counter is decremented by 1; and if reception of the PDSCH scheduled by the PDCCH on PO 2 fails, the counter is decremented by 1again. When the value of the counter is 0, the physical layer of the first terminal device sends an alert signal to the higher layer.

In some implementations, the first condition may be associated with the number of detection failures of the first channel (such as the PDCCH) and the number of reception failures of the second channel (such as the PDSCH). For example, the first condition may include a sum of the number of detection failures of the first channel and the number of reception failures of the second channel reaching threshold A. In other words, if the sum of the number of detection failures of the first channel and the number of reception failures of the second channel reaches threshold A, the first terminal device triggers the first signal. For example, if the first terminal device has not detected the PDCCH on PO 1, the value of the counter changes from 0 to 1; then, if the terminal device has detected the PDCCH on PO 2, but fails to receive the PDSCH in the PDSCH scheduled by the PDCCH, the value of the counter changes from 1 to 2. This process is repeated until the value of the counter reaches threshold A.

In some implementations, the first condition is associated with received quality of a second signal. The second signal may be, for example, one type or some types of reference signals. The second signal may include, for example, a synchronization signal block (synchronization signal block, SSB) and/or channel state information reference signal (channel state information reference signal, CSI-RS). The second signal is, for example, a first CSI-RS, and the first CSI-RS includes one or more of the following: a CSI-RS for radio link monitoring; a CSI-RS for beam failure detection; a tracking reference signal (tracking reference signal, TRS); or a CSI-RS dedicatedly used to trigger the first signal (for example, a CSI-RS dedicatedly used to trigger an alert signal).

In some implementations, the received quality of the second signal is determined based on a reference signal received power (reference signal receiving power, RSRP) and/or a signal-to-noise ratio (signal to noise ratio, SNR) of the second signal.

In some implementations, the first condition includes the received quality of the second signal being less than or equal to a third threshold.

In some implementations, to prevent the first signal from being triggered too frequently, or to prevent the first signal from being triggered falsely, the first condition may include that a number of times the received quality of the second signal is less than or equal to the third threshold reaches a first threshold value. In other words, when the number of times the received quality of the second signal is less than or equal to the third threshold reaches the first threshold value, the first terminal device triggers the first signal. The number of times the received quality of the second signal is less than or equal to the third threshold may be counted based on a counter.

In some implementations, that the number of times the received quality of the second signal is less than or equal to the third threshold reaches the first threshold value may include: a number of consecutive times the received quality of the second signal is less than or equal to the third threshold reaches the first threshold value. For example, the second signal is a reference signal that periodically appears. When the reference signal appears for the first time, if the first terminal device measures signal quality of the reference signal as being lower than the third threshold, a value of the counter changes from 0 to 1; when the reference signal appears for the second time, if the first terminal device measures the signal quality of the reference signal as being lower than the third threshold, the value of the counter changes from 1 to 2; when the reference signal appears for the third time, if the first terminal device measures the signal quality of the reference signal as being higher than the third threshold, the counter is then reset to zero. In other words, the first terminal device trigger the first signal only in a case that signal quality of the reference signal is lower than the third threshold for consecutive times.

In some implementations, that the number of times the received quality of the second signal is less than or equal to the third threshold reaches the first threshold value may include: a number of times the received quality of the second signal is less than or equal to the third threshold reaches the first threshold value within a first time window. For example, the second signal is a reference signal that periodically appears. When the reference signal appears for the first time, if the first terminal device measures signal quality of the reference signal as being lower than the third threshold, a value of the counter changes from 0 to 1, and at this moment, a timer is started. Timing duration of the timer represents the first time window. When the reference signal appears for the second time, if the first terminal device measures the signal quality of the reference signal as being lower than the third threshold, the value of the counter changes from 1 to 2; when the reference signal appears for the third time, if the first terminal device measures the signal quality of the reference signal as being higher than the third threshold, the value of the counter remains unchanged; when the reference signal appears for the fourth time, if the first terminal device measures the signal quality of the reference signal as being lower than the third threshold, and the timer has already expired, the counter is reset to zero.

In some implementations, the second signal is a reference signal corresponding to a beam, and that the number of times the received quality of the second signal is less than or equal to the third threshold reaches the first threshold value may include: a number of times the received quality of a reference signal corresponding to one beam direction is less than or equal to the third threshold reaches the first threshold value. In other words, if the number of times the received quality of the reference signal corresponding to one beam direction is less than or equal to the third threshold reaches the first threshold value, the first terminal device triggers the first signal.

In some implementations, the second signal is a reference signal corresponding to a beam (or a beam direction), and that the number of times the received quality of the second signal is less than or equal to the third threshold reaches the first threshold value may include: a number of times the received quality of reference signals corresponding to all beams is less than or equal to the third threshold reaches the first threshold value. In other words, if a number of times the received quality of a reference signal corresponding to a specific beam direction is less than or equal to the third threshold does not reach the first threshold, the first terminal device does not trigger the first signal, because in this case, the first terminal device can receive paging information by changing a beam direction. The correspondence between a beam and a reference signal may refer to a correspondence or association between a beam (or a beam direction) and an index that corresponds to a reference signal. A downlink reference signal is used as an example. Each index of a downlink reference signal may represent a beam (or a beam direction). For example, SSB index 1 may represent beam 1, and SSB index 2 may represent beam 2. Alternatively, CSI-RS resource index 1 may represent beam 1, and CSI-RS resource index 2 may represent beam 2.

FIG. 7 is a schematic flowchart of a wireless communication method according to another embodiment of this application. The method shown in FIG. 7 is described from a perspective of interaction between a first terminal device and a network device. For example, the first terminal device may be a terminal device that supports NTN communication (such as satellite communication). The network device may be a base station in an NTN network, for example, a satellite.

Referring to FIG. 7, in Step S710, the first terminal device detects or receives a first signal sent by the network device.

In some implementations, the first signal is an alert signal.

In some implementations, the first signal is associated with paging failure of the first terminal device. For example, the first signal is triggered in a case that paging of the first terminal device fails. For another example, the first signal is used to indicate that paging of the first terminal device fails.

In some implementations, the first signal is used to trigger the first terminal device to initiate a random access procedure, that is, a RACH procedure, to attempt to connect to a cell or the network device by using the random access procedure.

In some implementations, if the first terminal device has not detected or received the first signal, it may indicate that the first terminal device has not missed a paging message delivered by the network device. Further, in some implementations, the first terminal device may continue to monitor a paging message on a subsequent paging occasion configured for the first terminal device.

In some implementations, the first signal is used to indicate that a location of the first terminal device is unfavorable for signal reception from the network device. Alternatively, the first signal may be used to instruct a user of the terminal device to move to a location that facilitates signal reception from the network device.

Satellite communication is used as an example. The first signal may be used to notify (for example, through a user interface of the first terminal device) the user of the first terminal device that the first terminal device may be located in a location or area with poor satellite signal reception, for example, the first terminal device is in a pocket or under a roof that shields satellite signals. Based on the first signal, the user of the first terminal device may move to a location or area suitable for receiving satellite signals.

In some implementations, the first signal is used to trigger the first terminal device to send the target signal.

In some implementations, the target signal may be sent from a physical layer of the first terminal device to a higher level of the physical layer.

In some implementations, the target signal is an alert signal.

In some implementations, the target signal is associated with paging failure of the first terminal device. For example, the target signal is triggered in a case that paging of the first terminal device fails. For another example, the target signal is used to indicate that paging of the first terminal device fails.

In some implementations, the target signal is used to indicate that a location of the first terminal device is unfavorable for signal reception from the network device. Alternatively, the target signal may be used to instruct the user of the terminal device to move to a location that facilitates signal reception from the network device.

Satellite communication is used as an example. The target signal may be used to notify (for example, through a user interface of the first terminal device) the user of the first terminal device that the first terminal device may be located in a location or area with poor satellite signal reception, for example, the first terminal device is in a pocket or under a roof that shields satellite signals. Based on the target signal, the user of the first terminal device may move to a location or area suitable for receiving satellite signals.

In some implementations, the first signal is transmitted through a first transmission occasion, and the first transmission occasion is one of one or more transmission occasions configured for the first signal. An alert signal is used as an example of the first signal, and one or more alert occasions (alert occasion, AO) may be configured for the first terminal device.

In some implementations, one or more transmission occasions of the first signal are configured based on system information and/or RRC signaling. The RRC signaling may be, for example, RRC signaling dedicated to a terminal device.

In some implementations, the first transmission occasion is later than a first channel in time domain, where the first channel is used to schedule transmission of paging information of the first terminal device, and detection of the first channel fails. The first channel may be, for example, a PDCCH. The PDCCH is used to schedule a PDSCH, and the PDSCH is used to carry the paging information of the first terminal device. In other words, after detection of the first channel fails, the first terminal device may start to receive the first signal on the transmission occasions of the first signal, and the first signal is received on the first transmission occasion. An alert signal is used as an example of the first signal. As shown in FIG. 8, if the first terminal device fails to detect the PDCCH on a PO, the first terminal device may continue to detect or receive the alert signal on configured alert occasions. If the alert signal is detected or received, the first terminal device may be triggered to perform a RACH procedure.

In some implementations, the first transmission occasion is later than a first channel in time domain, where the first channel is used to transmit paging information of the first terminal device, and reception of the first channel fails. The first channel may be, for example, a PDSCH. The PDSCH is used to carry the paging information of the first terminal device. In other words, after detection of the first channel fails, the first terminal device may start to receive the first signal on transmission occasions of the first signal, and the first signal is received on the first transmission occasion.

In some implementations, reception of the first signal by the first terminal device may be triggered when reception or detection of the first channel fails.

In some implementations, the first transmission occasion is the 1^{st} transmission occasion, located after the first channel in time domain, among the one or more transmission occasions. In other words, after the first terminal device fails to detect or receive the first channel, the first terminal device may start to detect or receive the first signal on the 1^{st} transmission occasion located after the first channel. Certainly, if the first terminal device successfully detects or receives the first channel, the first terminal device may not detect or receive the first signal.

In some implementations, the first signal is triggered in a case that the network device determines that paging of the terminal device fails. For example, the network device schedules the paging information of the first terminal device and waits for the first terminal device to connect to the network, but the network device has not received a connection request sent by the first terminal device. If this case occurs, the network device may determine (or speculate) that the first terminal device has missed the paging information. Then, the network device may send the first signal to the first terminal device, to alert the first terminal device. The reason why the first terminal device has missed the paging information is possibly that the terminal device is located in a poor signal (for example, a satellite signal) receiving environment. Therefore, sending of the first signal helps the first terminal device promote, by using a user interface of the first terminal device, the user to move to a location with a better signal (for example, a satellite signal).

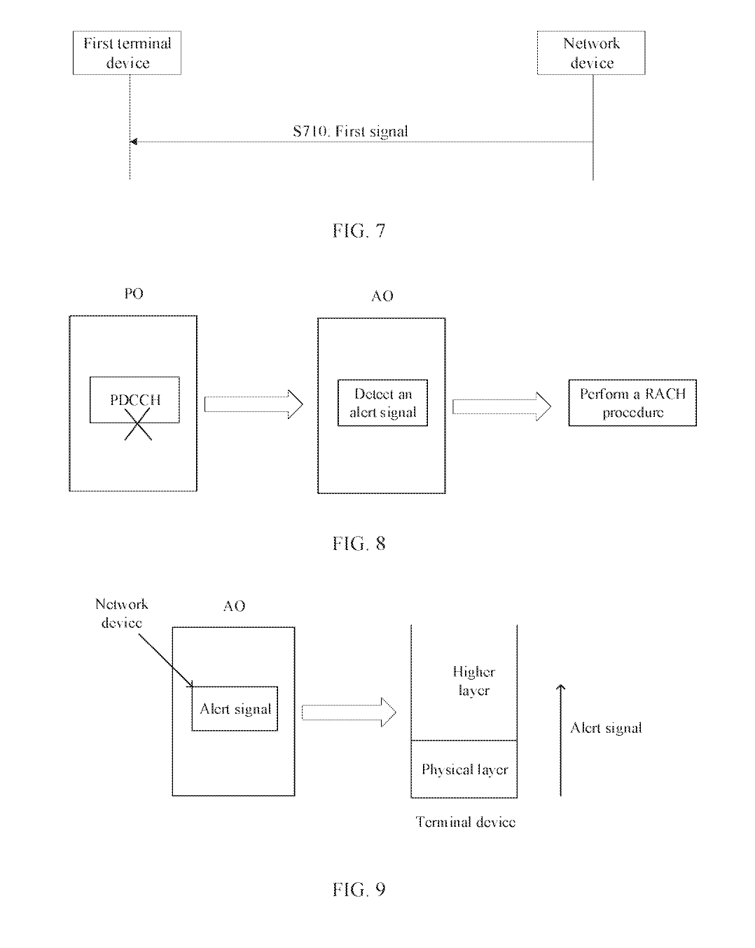

For example, the first signal is an alert signal. Referring to FIG. 9, if the network device determines that the first terminal device has missed the paging information, the network device may send the alert signal on a configured AO. After receiving the alert signal, the physical layer of the first terminal device may send the alert signal to the higher layer (This alert signal corresponds to the previously mentioned target signal).

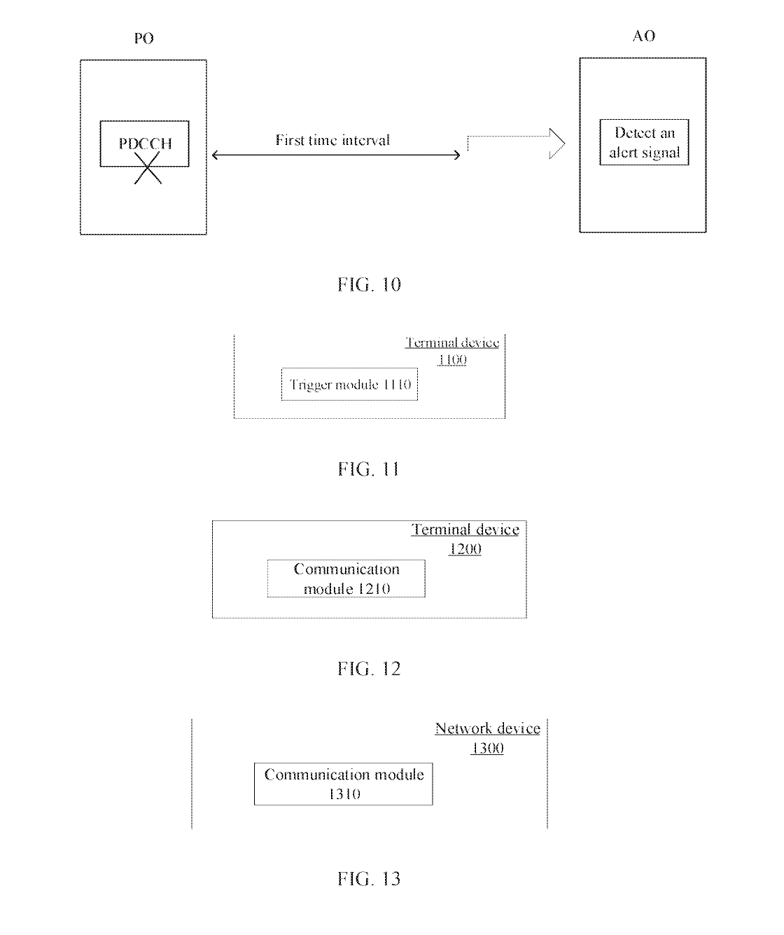

After sending the paging information to the first terminal device, the network device may not immediately notice that the first terminal device has missed the paging information. In other words, it may take a period of time before the network device notices that the first terminal device has missed the paging information. Therefore, the network device may not immediately send the first signal to the first terminal device on the 1^{st} transmission occasion (a poor transmission occasion of the first signal) located after a PO carrying the paging information. In this case, the first terminal device does not need to detect or receive the first signal on the 1^{st} transmission occasion located after the PO. Therefore, in some implementations, as shown in FIG. 10, after reception of the paging information fails, the terminal device may wait for a first time interval before starting to detect or receive the first signal (for example, the alert signal).

For example, the first channel carries the paging information, and the first terminal device fails to receive the first channel, or the first channel schedules transmission of the paging information, and the first terminal device fails to detect the first channel. The first terminal device may receive or detect the first signal on a first transmission occasion (a configured transmission occasion of the first signal) located after the first channel. A time interval between the first channel and the first transmission occasion is greater than or equal to the first time interval. The first time interval may start from a time domain start location or a time domain end location of the first channel.

For example, reception of a paging message on a first PO fails, and the first terminal device receives or detects the first signal on a first transmission occasion (a configured transmission occasion of the first signal) located after the first PO. A time interval between the first PO and the first transmission occasion may be greater than or equal to the first time interval. The first time interval may start from a time domain start location or a time domain end location of the first PO.

The first time interval mentioned above may be determined based on configuration information or pre-configuration information of the network device, or autonomous implementation by the first terminal device. For example, the first time interval may be indicated by the network device to or configured by the network device for the first terminal device by using a system message or RRC signaling.

In some implementations, the first transmission occasion is associated with an identifier of the first terminal device. An alert signal is used as an example of the first signal. If the first terminal device detects or receives an alert signal on an alert occasion associated with the identifier of the first terminal device, the alert signal is an alert signal for the first terminal device.

In some implementations, the first transmission occasion is associated with one or more terminal devices including the first terminal device. Alternatively, the first transmission occasion is associated with identifiers of one or more terminal devices including the first terminal device. For example, an association relationship between the identifier of the terminal device and a transmission occasion of the first signal may be determined based on the following formula: UE ID mod N, where UE ID represents the identifier of the terminal device, N is a positive integer, and mod represents a modulo operation. In this way, one transmission occasion of the first signal may be associated with one or more terminal devices. In this case, first signals respectively corresponding to one or more terminal devices may be included in the first transmission occasion. For example, the first transmission occasion may be associated with M terminal devices (M is a positive integer greater than or equal to 1). Correspondingly, the first transmission occasion includes a bitmap, and the bitmap includes M bits. The M bits are in a one-to-one correspondence with the M terminal devices. If a value of an i^{th} bit in the M bits is a first value (for example, 0), it may indicate that the first transmission occasion does not include a first signal for the terminal device corresponding to the i^{th} bit. If a value of an i^{th} bit in the M bits is a second value (for example, 1), it may indicate that the first transmission occasion includes a first signal for the terminal device corresponding to the i^{th} bit.

In some implementations, the first signal is carried on the first channel. The first channel is used to schedule transmission of paging information of the first terminal device. The first channel may be a PDCCH. The PDCCH schedules a PDSCH, and the PDSCH carries the paging information of the first terminal device. For example, the first terminal device may detect a PDCCH on a paging occasion, and then may detect DCI on the PDCCH. The DCI may include the first signal (for example, an alert signal) mentioned above.

The method embodiments of this application are described above in detail with reference to FIG. 1 to FIG. 10. Apparatus embodiments of this application are described below in detail with reference to FIG. 11 to FIG. 14. It should be understood that the descriptions of the method embodiments correspond to descriptions of the apparatus embodiments, and therefore, for parts that are not described in detail, reference may be made to the foregoing method embodiments.

FIG. 11 is a schematic structural diagram of a terminal device according to an embodiment of this application. A terminal device 1100 shown in FIG. 11 may be a first terminal device. The terminal device 1100 includes a trigger module 1110. The triggering module 1110 is configured to trigger a first signal if a first condition is met, where the first condition is associated with one or more of the following: detection failure of a first channel, where the first channel is used to schedule transmission of paging information of the first terminal device; reception failure of a second channel, where the second channel is used to transmit paging information of the first terminal device; or received quality of a second signal.

In some implementations, the first condition includes: detection of the first channel fails; or a number of detection failures of the first channel reaches a first threshold; or receiving of the second channel fails; or a number of receiving failures of the second channel reaches a second threshold; or received quality of the second signal is less than or equal to a third threshold.

In some implementations, the first channel is a PDCCH.

In some implementations, the second channel is a PDSCH.

In some implementations, the second signal includes an SSB and/or a CSI-RS.

In some implementations, the second signal is a first CSI-RS, and the first CSI-RS includes one or more of the following: a CSI-RS for radio link monitoring; a CSI-RS for beam failure detection; a tracking reference signal; or a CSI-RS dedicatedly used to trigger the first signal.

In some implementations, the received quality of the second signal is determined based on RSRP and/or an SNR of the second signal.

In some implementations, the first signal is sent by a physical layer of the first terminal device to a higher layer of the physical layer.

In some implementations, the first signal is used to trigger the first terminal device to initiate a random access procedure.

In some implementations, the first signal meets one or more of the following: the first signal is triggered in a case that a paging failure occurs; the first signal is used to indicate that paging of the first terminal device fails; or the first signal is used to indicate that a location of the first terminal device is unfavorable for signal reception from a network device.

In some implementations, the first signal is an alert signal.

FIG. 12 is a schematic structural diagram of a terminal device according to another embodiment of this application. The terminal device 1200 shown in FIG. 12 may be referred to as a first terminal device. The terminal device 1200 includes a communication module 1210. The communication module 1210 is configured to receive a first signal sent by a network device, where the first signal is associated with paging failure of the first terminal device.

In some implementations, the first signal is transmitted through a first transmission occasion, and the first transmission occasion is one of one or more transmission occasions configured for the first signal.

In some implementations, one or more transmission occasions of the first signal are configured based on system information and/or RRC signaling.

In some implementations, the first transmission occasion is later than a first channel in time domain, where the first channel is used to schedule transmission of paging information of the first terminal device, and detection of the first channel fails; or the first channel is used to transmit paging information of the first terminal device, and reception of the first channel fails.

In some implementations, the first transmission occasion is the 1^{st} transmission occasion, located after the first channel in time domain, among the one or more transmission occasions.

In some implementations, a time interval between the first transmission occasion and the first channel is greater than or equal to a first time interval.

In some implementations, the first channel is a PDSCH.

In some implementations, the first channel is a PDCCH.

In some implementations, reception of the first signal is triggered based on detection failure of the first channel.

In some implementations, the first transmission occasion is associated with an identifier of the first terminal device.

In some implementations, the first transmission occasion is associated with identifiers of one or more terminal devices including the first terminal device, and first signals respectively corresponding to the one or more terminal devices are included in the first transmission occasion.

In some implementations, the first signal is carried on a first channel, and the first channel is used to schedule transmission of paging information of the first terminal device.

In some implementations, the first channel is a PDCCH.

In some implementations, the first signal is used to trigger a physical layer of the terminal device to send a target signal to a higher layer of the physical layer, and the target signal is associated with paging failure of the first terminal device.

In some implementations, the first signal is used to trigger the first terminal device to initiate a random access procedure.

In some implementations, the first signal is used to indicate one or more of the following: paging of the first terminal device fails; or a location of the first terminal device is unfavorable for signal reception from the network device.

In some implementations, the first signal is an alert signal.

FIG. 13 is a schematic structural diagram of a network device according to an embodiment of this application. A network device 1300 shown in FIG. 13 includes a communication module 1310. The communication module 1310 is configured to send a first signal to a first terminal device, where the first signal is associated with paging failure of the first terminal device.

In some implementations, the first signal is transmitted through a first transmission occasion, and the first transmission occasion is one of one or more transmission occasions configured for the first signal.

In some implementations, one or more transmission occasions of the first signal are configured based on system information and/or RRC signaling.

In some implementations, the first transmission occasion is later than a first channel in time domain, where the first channel is used to schedule transmission of paging information of the first terminal device, and detection of the first channel fails; or the first channel is used to transmit paging information of the first terminal device, and reception of the first channel fails.

In some implementations, the first transmission occasion is the 1^{st} transmission occasion, located after the first channel in time domain, among the one or more transmission occasions.

In some implementations, a time interval between the first transmission occasion and the first channel is greater than or equal to a first time interval.

In some implementations, the first channel is a PDSCH.

In some implementations, the first channel is a PDCCH.

In some implementations, the first transmission occasion is associated with an identifier of the first terminal device.

In some implementations, the first transmission occasion is associated with identifiers of one or more terminal devices including the first terminal device, and first signals respectively corresponding to the one or more terminal devices are included in the first transmission occasion.

In some implementations, the first signal is triggered in a case that the network device determines that paging of the terminal device fails.

In some implementations, the first signal is carried on a first channel, and the first channel is used to schedule transmission of paging information of the first terminal device.

In some implementations, the first channel is a PDCCH.

In some implementations, the first signal is used to trigger a physical layer of the terminal device to send a target signal to a higher layer of the physical layer, and the target signal is associated with paging failure of the first terminal device.

In some implementations, the first signal is used to trigger the first terminal device to initiate a random access procedure.

In some implementations, the first signal is used to indicate one or more of the following: paging of the first terminal device fails; or a location of the first terminal device is unfavorable for signal reception from the network device.

In some implementations, the first signal is an alert signal.

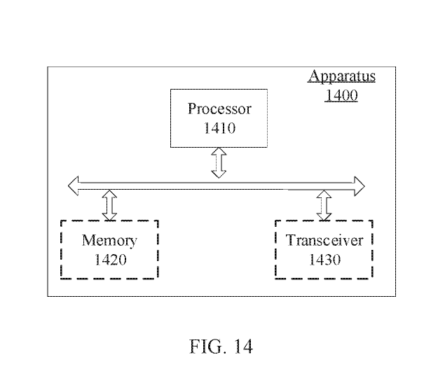

FIG. 14 is a schematic structural diagram of an apparatus according to an embodiment of this application. Dashed lines in FIG. 14 indicate that a unit or module is optional. The apparatus 1400 may be configured to implement the methods described in the foregoing method embodiments. The apparatus 1400 may be a chip, a terminal device, or a network device.

The apparatus 1400 may include one or more processors 1410. The processor 1410 may support the apparatus 1400 in implementing the methods described in the foregoing method embodiments. The processor 1410 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application specific integrated circuit, ASIC), a field programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 1400 may further include one or more memories 1420. The memory 1420 stores a program, and the program may be executed by the processor 1410, so that the apparatus 1400 executes the method described in the foregoing method embodiment. The memory 1420 may be separated from or integrated into the processor 1410.

The apparatus 1400 may further include a transceiver 1430. The processor 1410 may communicate with another device or chip through the transceiver 1430. For example, the processor 1410 may transmit data to and receive data from another device or chip through the transceiver 1430.

An embodiment of this application further provides a computer-readable storage medium for storing a program. The computer-readable storage medium may be applied to the terminal device or the network device provided in embodiments of this application, and the program causes a computer to execute the method executed by the terminal device or the network device in embodiments of this application.

An embodiment of this application further provides a computer program product. The computer program product includes a program. The computer program product may be applied to the terminal device or the network device provided in the embodiments of this application, and the program causes a computer to execute the methods performed by the terminal device or the network device in various embodiments of this application.

An embodiment of this application further provides a computer program. The computer program may be applied to the terminal device or the network device provided in the embodiments of this application, and the computer program causes a computer to execute the methods performed by the terminal device or the network device in various embodiments of this application.

It should be understood that, in embodiments of this application, “B that is corresponding to A” means that B is associated with A, and B may be determined based on A. However, it should be further understood that, determining B based on A does not mean determining B based only on A, but instead, B may be determined based on A and/or other information.

It should be understood that, in this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

It should be understood that, in embodiments of this application, sequence numbers of the foregoing processes do not mean execution sequences. The execution sequences of the processes should be determined based on functions and internal logic of the processes, and should not be construed as any limitation on the implementation processes of the embodiments of this application.

In several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (digital subscriber line, DSL)) manner or a wireless (for example, infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state drive (solid state drive, SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A wireless communication method, comprising:
triggering, by a first terminal device, a first signal if a first condition is met,
wherein the first condition is associated with one or more of the following:
detection failure of a first channel, wherein the first channel is used to schedule transmission of paging information of the first terminal device;
reception failure of a second channel, wherein the second channel is used to transmit the paging information of the first terminal device; or
received quality of a second signal.

2. The method according to claim 1, wherein the first condition comprises:
detection of the first channel fails; or
a number of detection failures of the first channel reaches a first threshold; or
receiving of the second channel fails; or
a number of receiving failures of the second channel reaches a second threshold; or
received quality of the second signal is less than or equal to a third threshold.

3. The method according to claim 1, wherein the first channel is a physical downlink control channel (PDCCH).

4. The method according to claim 1, wherein the second channel is a physical downlink shared channel (PDSCH).

5. The method according to claim 1, wherein the second signal comprises a synchronization signal block (SSB) and/or a channel state information reference signal (CSI-RS).

6. The method according to claim 1, wherein the first signal is used to trigger the first terminal device to initiate a random access procedure.

7. The method according to claim 1, wherein the first signal meets one or more of the following:
the first signal is triggered in a case that a paging failure occurs;
the first signal is used to indicate that paging of the first terminal device fails; or
the first signal is used to indicate that a location of the first terminal device is unfavorable for signal reception from a network device.

8. A wireless communication method, comprising:
receiving, by a first terminal device, a first signal sent by a network device, wherein the first signal is associated with paging failure of the first terminal device.

9. The method according to claim 8, wherein the first signal is used to trigger the first terminal device to initiate a random access procedure.

10. The method according to claim 8, wherein the first signal is used to indicate one or more of the following:
paging of the first terminal device fails; or
a location of the first terminal device is unfavorable for signal reception from the network device.

11. A wireless communication method, comprising:
sending, by a network device, a first signal to a first terminal device, wherein the first signal is associated with paging failure of the first terminal device.

12. The method according to claim 11, wherein the first signal is used to trigger the first terminal device to initiate a random access procedure.

13. The method according to claim 11, wherein the first signal is used to indicate one or more of the following:
paging of the first terminal device fails; or
a location of the first terminal device is unfavorable for signal reception from the network device.

14. A terminal device, wherein the terminal device is a first terminal device, and the first terminal device comprises a memory and a processor, wherein the memory is configured to store a program, and the processor is configured to invoke the program in the memory, to cause the first terminal device to perform the method according to claim 1.

15. The terminal device according to claim 14, wherein the first condition comprises:
detection of the first channel fails; or
a number of detection failures of the first channel reaches a first threshold; or
receiving of the second channel fails; or
a number of receiving failures of the second channel reaches a second threshold; or
received quality of the second signal is less than or equal to a third threshold.

16. The terminal device according to claim 14, wherein the first channel is a physical downlink control channel (PDCCH).

17. The terminal device according to claim 14, wherein the second channel is a physical downlink shared channel (PDSCH).

18. The terminal device according to claim 14, wherein the second signal comprises a synchronization signal block (SSB) and/or a channel state information reference signal (CSI-RS).

19. The terminal device according to claim 14, wherein the first signal is used to trigger the first terminal device to initiate a random access procedure.

20. The terminal device according to claim 14, wherein the first signal meets one or more of the following:
the first signal is triggered in a case that a paging failure occurs;
the first signal is used to indicate that paging of the first terminal device fails; or
the first signal is used to indicate that a location of the first terminal device is unfavorable for signal reception from a network device.
